(19) United States
(12) Patent Application Publication
(10) Pub. No.: US 2026/0017002 A1
(43) Pub. Date: Jan. 15, 2026

(54) PRINTING SYSTEM AND CORRECTION VALUE DETERMINATION METHOD

(71) Applicant: SEIKO EPSON CORPORATION, Tokyo (JP)

(72) Inventor: Eishin YOSHIKAWA, MATSUMOTO-SHI (JP)

(21) Appl. No.: 19/264,973

(22) Filed: Jul. 10, 2025

(30) Foreign Application Priority Data
Jul. 11, 2024 (JP) 2024-111592

(51) Int. Cl. G06F 3/12; B41J 29/393; G06K 15/02

(52) U.S. Cl. CPC G06F 3/1256; B41J 29/393; G06F 3/1208; G06K 15/027; B41J 2029/3935

(57) ABSTRACT

A printing system includes a printing device that prints a test pattern for determining a correction value used for adjusting a printing characteristic on a medium; an imaging section that is separate from the printing device and generates a captured image of the test pattern by capturing the test pattern; and a control section that acquires the captured image from the imaging section and performs processing of determining the correction value, wherein the control section determines a provisional value as the correction value when a provisional value is included in a predetermined acceptable range, the provisional value being obtained from the test pattern included in the captured image and determines an alternative correction value that is inside the boundary of the acceptable range as the correction value when the provisional value is outside the acceptable range.

The present application is based on, and claims priority from JP Application Serial Number 2024-111592, filed Jul. 11, 2024, the disclosure of which is hereby incorporated by reference herein in its entirety.

### BACKGROUND

### 1. Technical Field

The present disclosure relates to a printing system and a correction value determination method for determining a correction value for adjusting printing characteristics based on a captured image of a test pattern.

### 2. Related Art

A test pattern for adjusting printing characteristics of a printing device, such as an inkjet printer, is read by a scanner. Assuming that a mobile device with a camera, such as a smartphone, is used instead of a scanner to improve the convenience of adjusting print characteristics, the user will capture the test pattern while holding the mobile device with a camera in his/her hand. In this case, the angle and distance between the test pattern and the camera are not constant, and therefore, there is a possibility that a correction value within a normal range cannot be obtained from the test pattern in the captured image. If correction value is obtained that is normally impossible, the printing characteristics cannot be adjusted correctly.

For reference, an image forming apparatus disclosed in JP-A-2005-10269 compares a current detection value of a toner image density of a patch with a past detection value to determine whether or not the detection value is a correction limit or close to the correction limit, and when it is determined that the detection value is not the correction limit or close to the correction limit, repeats correction processing of correcting an exposure parameter for each patch formation so that the detection value approaches a predetermined reference value. When it is determined that the number of times the correction process has been executed has reached the upper limit but the correction limit has not yet been reached or is not close to being reached, the image forming device displays an abnormal termination on a UI display section and terminates the correction of the exposure parameters. An abnormal termination indication indicates a notification of an error, and means that the exposure parameter is not corrected.

When a user holds a mobile device with a camera in his/her hand and captures a test pattern, if a correction value within the normal range is not obtained and an error is notified, the user must again capture the test pattern with the mobile device with the camera and perform the work to obtain the correction value. If the correction value cannot be obtained, the printing characteristics cannot be adjusted, so the user must repeat the above steps until no errors occur. Therefore, it is desired to avoid inconveniences such as inappropriate adjustment of the printing characteristics due to an impossible correction value, or the inability to perform the adjustment work of the printing characteristics due to an error.

### SUMMARY

A printing system of the present disclosure includes an aspect of
a printing device that prints, on a medium, a test pattern for determining a correction value used for adjusting a printing characteristic;
an imaging section that is separate from the printing device and that generates a captured image of the test pattern by capturing the test pattern; and
a control section that acquires the captured image from the imaging section and that performs processing of determining the correction value, wherein
the control section
when a provisional value of the correction value is included in a predetermined acceptable range, determines the provisional value to be the correction value, the provisional value being obtained from the test pattern included in the captured image and
when the provisional value is outside the acceptable range, determines an alternative correction value that is inside a boundary of the acceptable range as the correction value.

a correction value determination method according to the present disclosure uses a printing device that prints, on a medium, a test pattern for determining a correction value used for adjusting a printing characteristic and an imaging section that is separate from the printing device and that generates a captured image of the test pattern by capturing the test pattern, the correction value determination method including
an image acquisition process for acquiring the captured image from the imaging section,
a first correction value determination step of determining a provisional value of the correction value as the correction value when the provisional value is included in a predetermined acceptable range, the provisional value being obtained from the test pattern included in the captured image; and
a second correction value determination step for determining an alternative correction value within the acceptable range that is inside the boundary of the acceptable range as the correction value when the provisional value is outside the acceptable range.

### BRIEF DESCRIPTION OF THE DRAWINGS

FIG. 1 is a diagram schematically illustrating an example of a printing system.

FIG. 2 is a diagram schematically illustrating a configuration example of a printing system.

FIG. 3 is a diagram schematically illustrating an example of a medium having a test pattern.

FIG. 4 is a diagram schematically illustrating an operation example of the information terminal at the time of imaging.

FIG. 5 is a diagram schematically illustrating an example of a captured image having a test pattern.

FIG. 6 is a diagram schematically illustrating an example of a correction value determination method.

FIGS. 7A and 7B are diagrams schematically illustrating examples of captured images having test patterns.

FIG. 8 is a flowchart schematically illustrating an example of a correction value determination process.

FIG. 9 is a diagram schematically illustrating an example of a correction value determined from a provisional value.

FIG. 10 is a diagram schematically illustrating an example of changing an alternative correction value according to a provisional value of a correction value.

### DESCRIPTION OF EMBODIMENTS

Hereinafter, embodiments of the present disclosure will be described. Of course, the following embodiments merely exemplify the present disclosure, and not all features shown in the embodiments are necessarily essential to the solutions in the present disclosure.

### (1) Outline of Aspects Included in the Present Disclosure

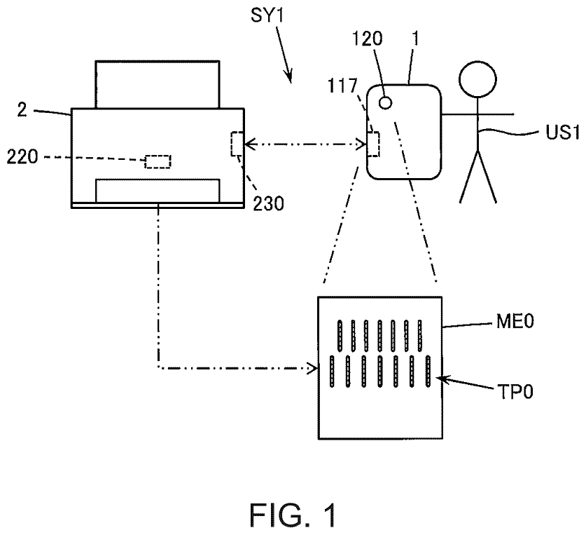

First, an overview of aspects included in the present disclosure will be described with reference to examples shown in FIGS. 1 to 10. Note that the drawings of the present application are diagrams that schematically show examples, and the magnification ratios in the directions illustrated in these drawings may differ, and the respective drawings may not match. Of course, each element of the present aspect is not limited to a specific example indicated by a reference numeral. In the “Outline of aspects included in the present disclosure”, terms in parentheses mean a supplementary explanation of the immediately preceding term.

### First Aspect

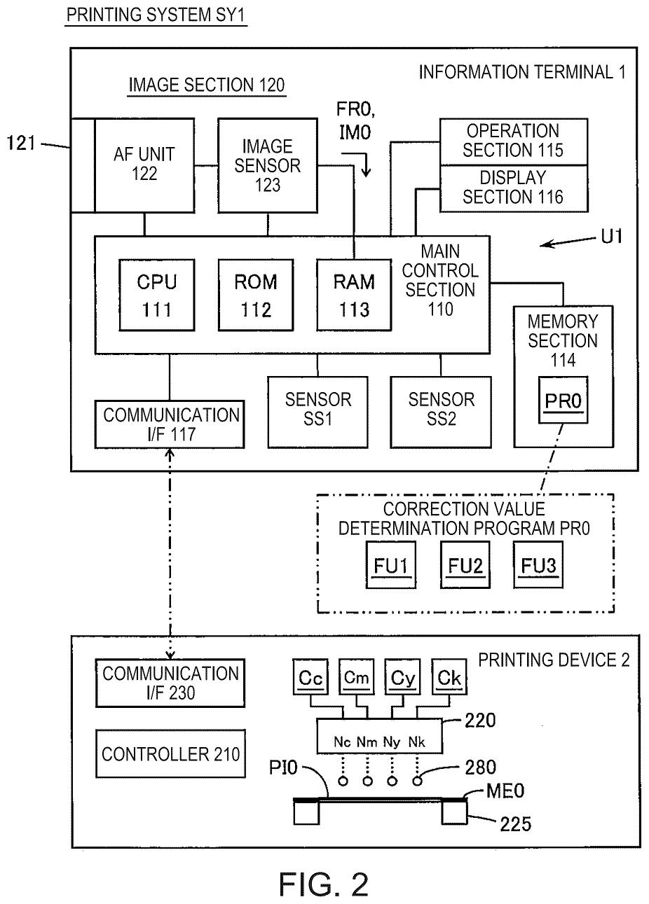

As illustrated in FIGS. 1 and 2, a printing system SY1 according to an aspect includes a printing device 2, an imaging section 120, and a control section U1. The printing device 2 prints a test pattern TP0 for determining a correction value V4 used for adjusting the printing characteristics on the medium ME0. The imaging section 120 is separate from the printing device 2, and generates a captured image IM0 of the test pattern TP0 by capturing an image of the test pattern TP0. The control section U1 acquires the captured image IM0 from the imaging section 120, and performs a process of determining the correction value V4. The control section U1 determines a provisional value V3 of the correction value V4, which is obtained from the test pattern TP0 included in the captured image IM0, to be the correction value V4 when the provisional value V3 is within a predetermined acceptable range R2, and determines the alternative correction value V5, which is inside the boundary R2b of the acceptable range R2, to be the correction value V4 when the provisional value V3 is outside the acceptable range R2.

When the provisional value V3 of the correction value V4 is included in the acceptable range R2, the provisional value V3 is determined to be the correction value V4. When the provisional value V3 is outside the acceptable range R2, the alternative correction value V5 that is inside the boundary R2b of the acceptable range R2 is determined to be the correction value V4. The reason why the alternative correction value V5 is inside the boundary R2b of the acceptable range R2 is because the possibility that the true correction value V4 is outside the acceptable range R2 is low, and the possibility that the true correction value V4 is on the boundary R2b of the acceptable range R2 is also low. For this reason, it is possible to avoid inconveniences such as inappropriate adjustment of the printing characteristics due to an impossible correction value V4, or the inability to perform the adjustment work of the printing characteristics due to an error. Therefore, the first aspect can provide a printing system that can improve usability when adjusting printing characteristics based on a captured image of a test pattern captured by an imaging section that is separate from a printing device.

The aspects described above include various examples.

Examples of the printing characteristics include the landing position of the liquid droplet, the transport amount of the medium, the liquid droplet ejection state of each nozzle, the density of the print image, and the like.

Examples of the test pattern include a Bi-d adjustment pattern for performing Bi-d adjustment (bidirectional adjustment) for matching the landing positions of the liquid droplets in the forward pass and the return pass, a transport amount adjustment pattern for adjusting the transport amount of the medium on which the print image is formed, a nozzle check pattern indicating the liquid droplet ejection state of each nozzle of the recording head, a density pattern for adjusting the density of the print image, and the like. Acquiring the captured image may be storing the captured image obtained from the imaging section in a memory, or may be a a DMA (direct memory access) controller controlling to store the captured image in the memory. Storing in the memory includes storing in a RAM (random access memory), storing in a non-volatile memory, and the like.

Obtaining the provisional value of the correction value includes obtaining that the provisional value is equal to or larger than a certain value or equal to or smaller than a certain value because the provisional value is outside of an acceptable range, or that the provisional value cannot be determined because the provisional value is outside of an acceptable range.

Of course, the above-mentioned additional remarks also apply to the following aspects.

### Second Aspect

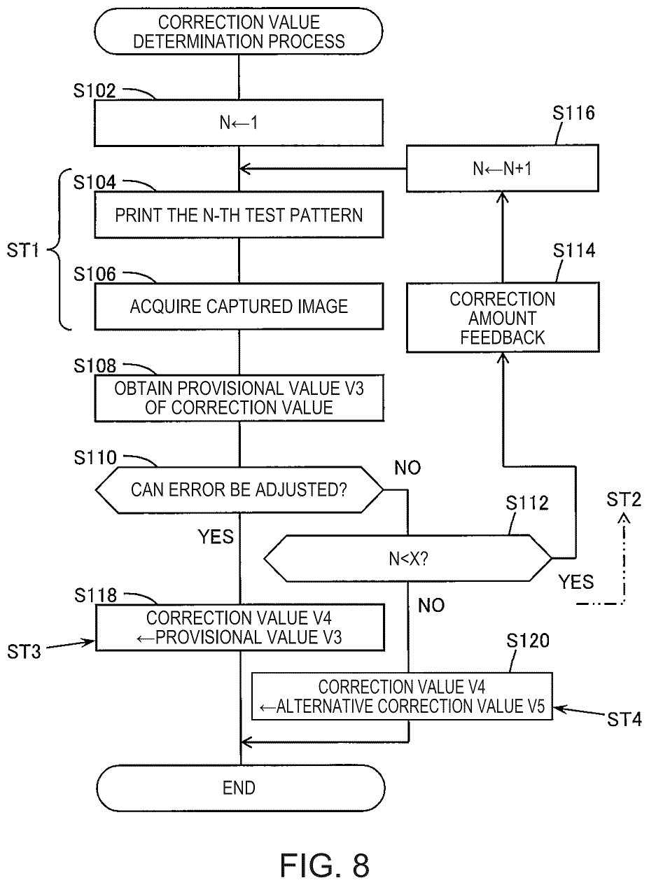

As illustrated in FIG. 8, the control section U1 may perform a print imaging process (e.g., steps S104 to S106 illustrated in FIG. 8) in which the printing device 2 prints the test pattern TP0 for obtaining the provisional value V3 within a predetermined correction range R1 based on the adjustment reference value V1, and the imaging section 120 captures the test pattern TP0 to obtain the captured image IM0 from the imaging section 120. The control section U1 may be capable of executing the print imaging process (X−1) times, where X is an integer greater than or equal to 2, by changing the reference value V1 to the boundary value V2 of the correction range R1 when the provisional value V3 obtained from the test pattern TP0 included in the captured image IM0 is outside the correction range R1. The acceptable range R2 may be X times the correction range R1.

When the provisional value V3 is outside a predetermined correction range R1 with the adjustment reference value V1 as a reference, the reference value V1 is changed to a boundary value V2 of the correction range R1, and the print imaging processing is repeated at least once. Therefore, the above aspect can ensure a broad range in which the printing characteristics can be adjusted by the test pattern without complicating the test pattern.

### Third Aspect

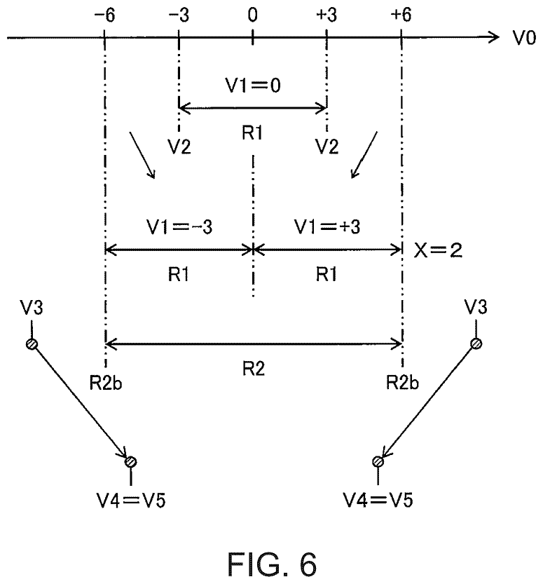

As illustrated in FIG. 6 and the like, the correction value V4 may be a value that can be positive or negative with reference to 0, which is a value at which the printing characteristics are not adjusted. The alternative correction value V5 may be a positive value smaller than the provisional value V3 when the provisional value V3 is positive, or may be a negative value larger than the provisional value V3 when the provisional value V3 is negative.

Even if the provisional value V3 of the correction value V4 is an abnormal value, there is a high possibility that the adjustment direction of the printing characteristics is the same direction as the sign of the provisional value V3. Since the alternative correction value V5 has the same sign as the provisional value V3, it is possible to determine a correction value that is effective when adjusting the printing characteristics to some extent.

### Fourth Aspect

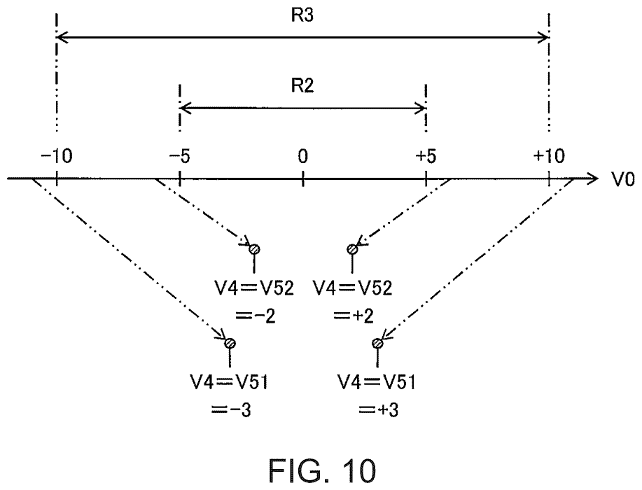

As illustrated in FIG. 10, the alternative correction value V5 may include a first alternative correction value V51 and a second alternative correction value V52, which is between the first alternative correction value V51 and 0. The control section U1 may determine the first alternative correction value V51 to be the correction value V4 when, in a case where the provisional value V3 is outside the acceptable range R2, the provisional value R3 is outside an expansion range R3, which is broader than the acceptable range R2. The control section U1 may determine the second alternative correction value V52 to be the correction value V4 when, in a case where the provisional value V3 is outside the acceptable range R2, the provisional value V3 is included in the expansion range R3.

When the provisional value V3 is outside the expansion range R3, which is broader than the acceptable range R2, there is a high possibility that the printing characteristics have deviated by a relatively large amount. On the other hand, when the provisional value V3 is outside the acceptable range R2 but is included in the expansion range R3, the deviation of the printing characteristics is likely to be smaller than that when the provisional value V3 is outside the expansion range R3. When the provisional value V3 is outside the acceptable range R2, the correction value V4 is determined according to the degree of deviation, and therefore the above aspect can determine an even more effective correction value when adjusting the printing characteristics to a certain extent.

Here, “first”, “second”, and the like in the present application are terms for identifying components included in a plurality of components that have similarities, and do not mean the order. The above-mentioned additional remarks also apply to the following aspects.

### Fifth Aspect

Incidentally, a correction value determination method according to an aspect is a method for determining the correction value V4 using the printing device 2 and the imaging section 120, and includes the following processes as illustrated in FIG. 8.

(a1) An image acquisition process ST1 for acquiring the captured image IM0 from the imaging section 120.

(a2) A first correction value determination process ST3 for determining the provisional value V3 of the correction value V4 as the correction value V4 when the provisional value V3 is included in a predetermined acceptable range R2, the provisional value V3 being obtained from the test pattern TP0 included in the captured image IM0.

(a3) A second correction value determination process ST4 for determining, when the provisional value V3 is outside the acceptable range R2, an alternative correction value V5 that is inside the boundary R2b of the acceptable range R2 as the correction value V4.

The above aspect can provide a correction value determination method that can improve usability when adjusting printing characteristics based on a captured image of a test pattern captured by an imaging section separate from a printing device.

Furthermore, the above-described aspects are applicable to an information processing device including the above-described control section, a control method of the information processing device, a control method of the above-described printing system, a correction value determination program, a control program of the above-described printing system, a computer-readable non-transitory medium in which any of the above-described programs is recorded, and the like. Any of the devices described above may be comprised of multiple parts that are distributed.

### (2) Specific Example of Correction Value Determination Program

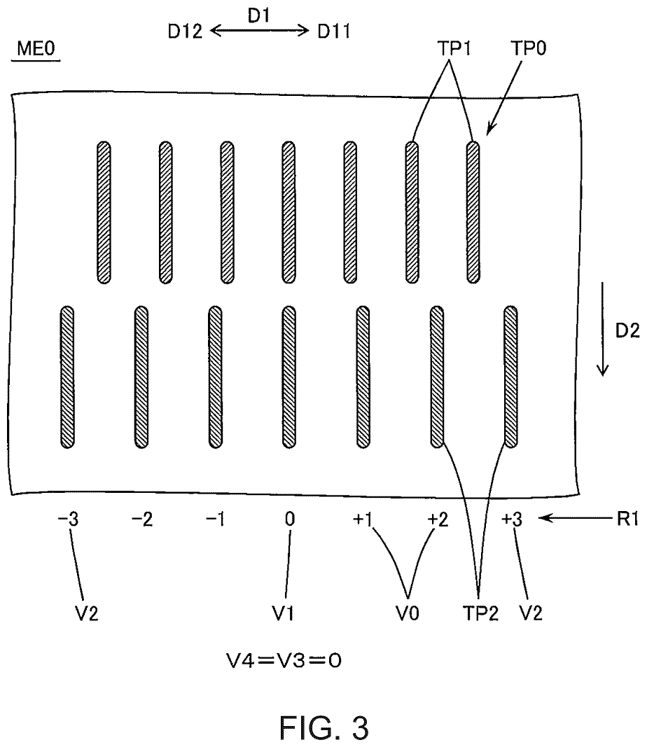

FIG. 1 schematically illustrates the printing system SY1 including the information terminal 1 and the printing device 2. FIG. 2 schematically illustrates the configuration of the printing system SY1. FIG. 3 schematically illustrates a medium ME0 having a test pattern TP0.

The information terminal 1 is a separate body from the printing device 2, and includes an imaging section 120 and a control section U1. Examples of the information terminal 1 include a mobile phone such as a smartphone, a tablet terminal, and a digital camera. The information terminal 1 may be configured as a plurality of devices that can communicate with each other, or as a stationary type device with a position-changeable imaging section coupled to it. The printing device 2 is assumed to be an inkjet printer including a recording head 220 capable of ejecting droplets 280. Of course, the printing device 2 may be a thermal printer (including a thermal transfer printer) provided with a thermal head as a recording head, It may be an electrophotographic printer (for example, a laser printer) equipped with a recording head that deposits toner onto the medium ME0, a three dimensional printer, or the like. The printing device 2 may be configured as a plurality of devices that can communicate with each other. The printing device 2 is capable of forming a print image PI0 including a test pattern TP0 for determining correction value V4 used for adjusting printing characteristics on a medium ME0. The correction value V4 is also referred to as an adjustment value.

The user US1 can adjust the printing characteristics of the printing device 2 by capturing an image of the test pattern TP0 with the information terminal 1, which includes the imaging section 120 separate from the printing device 2. When the user US1 holds the information terminal 1 in his/her hand and captures the test pattern TP0, there is a possibility that the camera will move around, the test pattern TP0 will be inclined, the test pattern TP0 will be too far from the imaging section 120, or the imaging environment will be too dark. Therefore, there is a possibility that the values indicated for adjusting the print characteristic by the test pattern TP0 in the captured image IM0 are not within the normal range. When the value for adjusting the printing characteristics is not within the normal range, the printing characteristics cannot be adjusted correctly. When an error is notified in a case where the value for adjusting the printing characteristics is not within the normal range, the user US1 needs to again capture the test pattern TP0 with the information terminal 1 and perform work for obtaining the value for adjusting the printing characteristics. If this value is not obtained, the print characteristics cannot be adjusted, and therefore the user US1 needs to perform the above-described operation until no error occurs.

In this specific example, when the provisional value V3 of the correction value V4 is outside the acceptable range R2 (see FIG. 6), the above-mentioned inconvenience is avoided by determining an alternative correction value V5 that is inside the boundary R2b of the acceptable range R2 as the correction value V4. The acceptable range R2 means a range that can be taken as the correction value V4, and it is generally assumed that the correction value V4 will not deviate from the acceptable range R2.

A communication interface (I/F) 117 of the information terminal 1 can communicate with a communication I/F 230 of the printing device 2. The information terminal 1 can transmit the correction value V4 of the printing characteristics and the like to the printing device 2 via the communication I/Fs 117 and 230. When the printing device 2 receives the correction value V4, the printing device 2 stores the correction value V4 and adjusts the printing characteristics based on the correction value V4. The communication by the communication I/Fs 117 and 230 may be wireless communication according to the standards for a wireless LAN (Local Area Network), wired communications, or network communications such as the Internet.

The information terminal 1 illustrated in FIG. 2 includes a main control section 110, a memory section 114, an operation section 115, a display section 116, the communication I/F 117, and an imaging section 120. The information terminal 1 may include sensors SS1 and SS2 connected to the main control section 110. The main control section 110 includes a central processing unit (CPU) 111 which is a processor, a read only memory (ROM) 112, and a random access memory (RAM) 113. The RAM 113 is an example of a memory for storing the captured image IM0 obtained from the imaging section 120. The elements of the information terminal 1 other than the imaging section 120 (110, 114 to 117, and the like) are examples of the control section U1.

The memory section 114 stores an operating system (OS), an application program, and the like. The application program includes a correction value determination program PR0 for capturing a medium ME0 having a test pattern TP0. As the memory section 114, a non-volatile semiconductor memory such as flash memory can be used. The memory section 114 may be removably attached to the main body of the information terminal 1. The display section 116 displays a screen corresponding to the display information based on the display information. A liquid crystal display panel or the like can be used for the display section 116. As the operation section 115 may be a touch panel attached to the surface of the display section 116, a hard key, or the like. The display section 116 displays a screen corresponding to the display information based on the display information.

The correction value determination program PR0 causes the information terminal 1 to realize a judgment function FU1, a first correction value determination function FU2, and a second correction value determination function FU3. The CPU 111 appropriately reads information stored in the memory section 114 to the RAM 113 and executes the read programs to perform various processes. The CPU 111 executes the correction value determination program PR0 read out to the RAM 113, thereby performing processing corresponding to the above-described functions (FU1 to FU3). The information terminal 1 executing the correction value determination program PR0 performs a judgment process ST2 corresponding to the judgment function FU1, a first correction value determination process ST3 corresponding to the first correction value determination function FU2, and a second correction value determination process ST4 corresponding to the second correction value determination function FU3. The computer-readable medium storing the correction value determination program PR0 that causes the computer to realize the above-described functions (FU1 to FU3) are not limited to the memory section 114, and may be an external recording medium of the information terminal 1.

The imaging section 120 includes a lens 121, an autofocus (AF) unit 122, an image sensor 123, and the like, and generates a captured image IM0 of the test pattern TP0 by capturing an image of the test pattern TP0. The image sensor 123 converts an image of light incident via the lens 121 and the AF unit 122 into an electric signal. In this specific example, the image sensor 123 outputs digital data corresponding to an electric signal of each light receiving element. The digital data is stored in the RAM 113 as a frame FR0 and the captured image IM0. As the image sensor 123, a complementary metal-oxide semiconductor (CMOS) image sensor, a charge coupled device (CCD) image sensor, or the like can be used.

The sensor SS1 may be a speed sensor that measures the moving speed of the imaging section 120 or an acceleration sensor that measures the acceleration of the imaging section 120. The sensor SS2 may be a distance measuring sensor that measures the distances from the imaging section 120 to the medium ME0.

The printing device 2 ejects cyan (C) ink, magenta (M) ink, yellow (Y) ink, and black (K) ink as droplets 280 from a recording head 220 to form a print image PI0 corresponding to the print data. The recording head 220 includes a plurality of nozzles Nc capable of ejecting C ink droplets onto the medium ME0, a plurality of nozzles Nm capable of ejecting M ink droplets onto the medium ME0, a plurality of nozzles Ny capable of ejecting Y ink droplets onto the medium ME0, and a plurality of nozzles Nk capable of ejecting K ink droplets onto the medium ME0. The recording head 220 is supplied with C, M, Y, and K inks from ink cartridges Cc, Cm, Cy, and Ck, respectively. The recording head 220 ejects C, M, Y, and K droplets 280 from the nozzles Nc, Nm, Ny, and Nk, respectively, under the control of the controller 210. When a droplet 280 lands on the medium ME0, an ink dot is formed on the medium ME0. The printing device 2 includes a drive section that changes the relative positional relationship between the recording head 220 and the medium ME0 under the control of the controller 210, example, a transport section 225 that transports the medium ME0 in a predetermined transport direction. As a result, printed matter is obtained with a pattern of ink dots as the print image PI0 on the medium ME0. The material of the medium ME0 is not particularly limited and may be paper, fabric, resin, metal, or the like. The shape of medium ME0 may be a cut two-dimensional shape, a roll shape, or a three-dimensional shape.

The medium ME0 shown in FIG. 3 has a Bi-d adjustment pattern as the test pattern TP0. The test pattern TP0 includes a plurality of forward pass individual patterns TP1 and the same number of return pass individual patterns TP2 as the forward pass individual patterns TP1. Each of the individual patterns (TP1, TP2) is a print image in the form of a line segment extending along a sub-scanning direction D2, which is perpendicular to a main scanning direction D1. For convenience, FIG. 3 shows values V0 corresponding to each return pass individual pattern TP2. The value V0 becomes the correction value V4 when the position of the return pass individual pattern TP2 matches the position of the corresponding forward pass individual pattern TP1 in the main scanning direction D1.

Bi-d adjustment means setting a correction value V4 to align the landing positions of droplets 280 on the forward pass and the landing positions of droplets 280 on the return pass in the main scanning direction D1 when the printing device 2 repeats main scanning and sub-scanning during printing. Here, forward pass refers to a main scan in which the recording head 220 moves in the forward direction D11, and the return pass refers to a main scan in which the recording head 220 moves in the return direction D12. The printing device 2 prints each forward pass individual pattern TP1 on the medium ME0 in the forward pass, and prints each return pass individual pattern TP2 on the medium ME0 in the return pass. FIG. 3 shows that the plurality of return pass individual patterns TP2 are shifted from the plurality of forward pass individual patterns TP1 in the sub-scanning direction D2, which is perpendicular to the main scanning direction D1. The plurality of return pass individual patterns TP2 may be located at the same position in the sub-scanning direction D2 as the plurality of forward pass individual patterns TP1. The sub-scanning direction D2 means a direction in which the recording head 220 moves relative to the medium ME0, and the transport direction in which the medium ME0 moves relative to the recording head 220 is the opposite of the sub-scanning direction D2.

In FIG. 3, the printing interval between the return pass individual patterns TP2 is, for example, one pixel wider than the printing interval between the forward pass individual patterns TP1. The value V0 corresponding to each return pass individual pattern TP2 is an integer value that can be either positive or negative, with 0 being the reference at which the printing characteristics are not adjusted. Among the seven values V0, “0” at the center means the reference value V1 at the initial stage of adjustment. Among the seven values V0, “+3”, which is the farthest from the reference value V1 in the forward direction D11, means a positive boundary value V2 in the correction range at the initial stage of adjustment. Among the seven values V0, “−3”, which is the farthest from the reference value V1 in the return direction D12, means a negative boundary value V2 in the correction range at the initial stage of adjustment. For example, the return pass individual pattern TP2 of “+3” means that it is shifted by three pixels in the forward direction D11 with respect to the return pass individual pattern TP2 with a reference value of “0”. The return pass individual pattern TP2 of “−3” means that it is shifted by three pixels in the return direction D12 with respect to the return pass individual pattern TP2 with a reference value of “0”. The test pattern TP0 shown in FIG. 3 can be said to be a Bi-d adjustment pattern for determining the provisional value V3 of the correction value V4 from among values equal to or less than −4, −3, −2, −1, 0, +1, +2, +3, and equal to or more than +4. As shown in FIG. 3, when the position of the return pass individual pattern TP2 having the reference value “0” in the main scanning direction D1 matches the position of the forward pass individual pattern TP1, the provisional value V3 is “0”, and as a result, the correction value V4 is “0”.

It should be noted that the test pattern TP0 is not limited to the Bi-d adjustment pattern, and may also be a PF adjustment pattern (transport amount adjustment pattern), a nozzle check pattern, a concentration pattern, or the like. For example, PF adjustment refers to setting a correction value V4 for adjusting the transport amount of the medium ME0 during sub-scanning in the sub-scanning direction D2 so as to be neither excessive nor insufficient. When the transport amount of medium ME0 during sub-scanning is too large, streaks that create gaps between band areas, such as light streaks, will occur, and when the transport amount of medium ME0 during sub-scanning is too small, streaks where dots overlap between band areas, such as dark streaks will occur. The PF adjustment pattern may be, for example, a collection of individual patterns that indicate whether or not the above-described streak is eliminated.

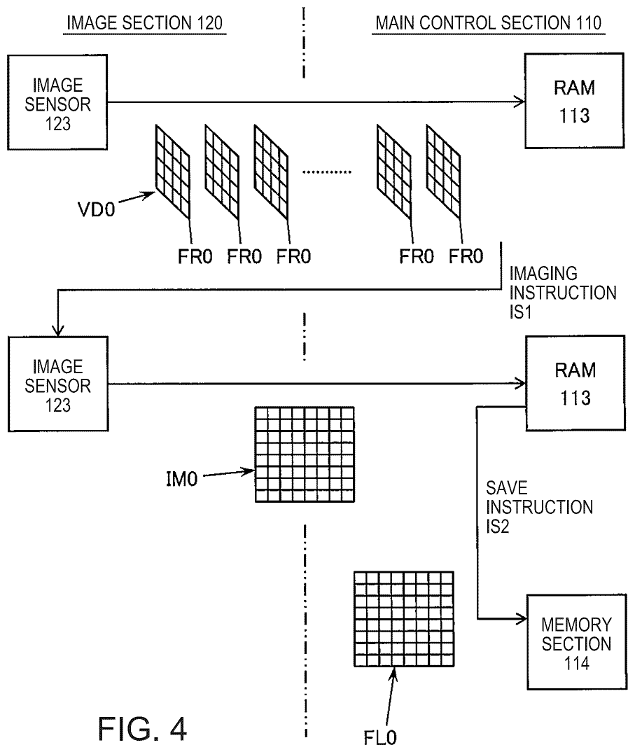

Next, an example of the operation of the information terminal 1 during imaging will be described with reference to FIG. 4 In general, imaging is triggered by an operation on a shutter button included in the operation section 115.

A frame FR0 constituting a video VD0 is transferred from the image sensor 123 of the imaging section 120 to the RAM 113 of the main control section 110 for each frame period. At this time, the CPU 111 may perform the process of storing the frame FR0 in the RAM 113, or a DMA controller (not shown) may perform the process of storing the frame FR0 in the RAM 113. Each frame FR0 represents a still image for each frame period but as information may have a difference from the previous frame. Due to the processing capability of the information terminal 1, each frame FR0 has a lower resolution than the captured image IM0. The main control section 110 controls the AF unit 122 and the like based on the frame FR0 group. The main control section 110 may cause the display section 116 to display each frame FR0.

When the user US1 performs an operation of pressing or touching the shutter button, the operation section 115 receives the operation, and the operation section 115 notifies the main control section 110 that the shutter button was operated. Then, the main control section 110 issues an imaging instruction IS1 to the imaging section 120 to cause the imaging section 120 to capture an image. The captured image IM0 generated by this imaging has a resolution higher than that of frame FR0 and is stored in the RAM 113. Here, the CPU 111 may perform the process of storing the captured image IM0 in the RAM 113, or the DMA controller (not shown) may perform the process of storing the captured image IM0 in the RAM 113. When the user US1 performs an operation for storing the captured image IM0, the operation section 115 receives the operation, and the operation unit 115 notifies the main control section 110 of the save instruction IS2. Then, the main control section 110 stores the captured image IM0 in the memory section 114 in the format of a file FL0. Examples of the file format include JPEG (Joint Photographic Experts Group) format and bitmap format, and the like.

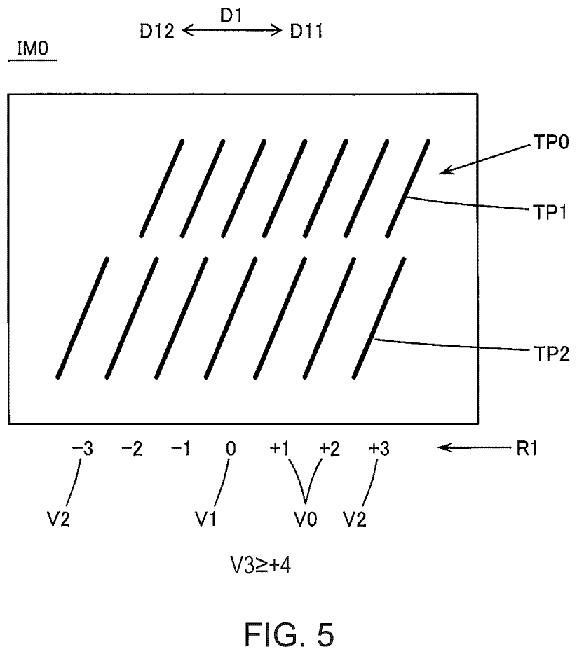

In this example, as illustrated in FIG. 5, the provisional value V3 of the correction value V4 is calculated based on a test pattern TP0 included in a captured image IM0. FIG. 5 schematically illustrates a captured image IM0 having a test pattern TP0.

As described above, when user US1 holds the information terminal 1 in his/her hand and captures the test pattern TP0, the angle and distance between the test pattern TP0 and the imaging section 120 are not constant, which may result in the provisional value V3 of the correction value V4 not being obtained correctly. The provisional value V3 cannot be obtained correctly even if the main control section 110 performs a process, based on the test pattern TP0 included in the captured image IM0 as shown in FIG. 5, to identify the position of the corresponding return pass individual pattern TP2 that is aligned with the position of the forward pass individual pattern TP1 in the main scanning direction D1. FIG. 5 illustrates an example in which the information terminal 1 erroneously obtains the provisional value V3 based on the test pattern TP0 included in the captured image IM0 as “+4 or more”, which is outside the correction range R1. In this case, the provisional value V3 cannot be used as the correction value V4 as it is.

First, an example of a correction value determination method will be described with reference to FIG. 6. The determined correction value V4 is a value that can be either positive or negative, with 0 as the reference value at which printing characteristics are not adjusted.

As shown in FIG. 3, the first printed test pattern TP0 has a correction range R1 ranging from a boundary value V2=−3 to a boundary value V2=+3, with a reference value V1=0 as the reference. The test pattern TP0 shown in FIG. 3 can be said to be a test pattern for obtaining a provisional value V3 within the correction range R1 with V1=0 as the reference. When the obtained provisional value V3 is equal to or greater than −3 and equal to or less than +3, the correction value V4 is determined to be the provisional value V3.

When the provisional value V3 is less than or equal to −4, the reference value V1 is changed to the boundary value V2=−3, and a test pattern TP0 is printed to obtain the provisional value V3 within the correction range R1 from the boundary value V2=−6 to the boundary value V2=0. When the provisional value V3 obtained here is equal to or greater than −6 and equal to or less than 0, the correction value V4 is determined to be the provisional value V3.

When the provisional value V3 is +4 or greater, the reference value V1 is changed to the boundary value V2=+3, and a test pattern TP0 is printed to obtain the provisional value V3 within the correction range R1 from boundary value V2=0 to boundary value V2=+6. When the provisional value V3 obtained here is equal to or greater than 0 and equal to or less than +6, the correction value V4 is determined to be the provisional value V3.

In FIG. 6, the upper limit number of times X of the test pattern printing is 2, and the acceptable range R2 of the provisional value V3 is from −6 to +6. That is, the acceptable range R2 is X=2 times the correction range R1.

When the obtained provisional value V3 is equal to or smaller than −7, the provisional value V3 is out of the acceptable range R2. In this case, the correction value V4 is determined to be an alternative correction value V5 that is inside the boundary R2b of the acceptable range R2, that is, a value equal to or greater than −5 and equal to or less than +5. This is because the possibility that the true correction value V4 is smaller than the acceptable range R2 is low, and the probability that the true correction value V4 is in the boundary R2b of the acceptable range R2 is also low. The alternative correction value V5 is preferably equal to or greater than −5 and equal to or less than −1, and may be −5 or −4 that is not included in the first correction range R1 but is included in the second correction range R1. In this case, the alternative correction value V5 can be said to be a negative value larger than the provisional value V3 when the provisional value V3 is negative. Even if the provisional value V3 is a negative value that normally is not possible, there is a high possibility that the adjustment direction of the printing characteristics is the same negative direction as the sign of the provisional value V3. Since the alternative correction value V5 has the same sign as the provisional value V3, the correction value V4 that is effective when adjusting the printing characteristics to some extent is determined.

xxxWhen the obtained provisional value V3 is equal to or greater than +7, the provisional value V3 is out of the acceptable range R2. In this case as well, the correction value V4 is determined to be an alternative correction value V5 that is inside the boundary R2b of the acceptable range R2, that is, is greater than or equal to −5 and less than or equal to +5. This is because the possibility that the true correction value V4 is greater than the acceptable range R2 is low, and the probability that the true correction value V4 is in the boundary R2b of the acceptable range R2 is also low. The alternative correction value V5 is preferably greater than or equal to +1 and less than or equal to +5, and may be +4 or +5 that is not included in the first correction range R1 but included in the second correction range R1. In this case, the alternative correction value V5 can be said to be a positive value smaller than the provisional value V3 when the provisional value V3 is positive. Even if the provisional value V3 is a positive value that normally is impossible, there is a high possibility that the adjustment direction of the printing characteristics is the same positive direction as the sign of the provisional value V3. Since the alternative correction value V5 has the same sign as the provisional value V3, the correction value V4 that is effective when adjusting the printing characteristics to some extent is determined.

When the upper limit number of times X is 3, the acceptable range R2 of the provisional value V3 is −9 or more and +9 or less. In this case, the acceptable range R2 is X=3 times the correction range R1. Of course, the upper limit number of times X may be four or more.

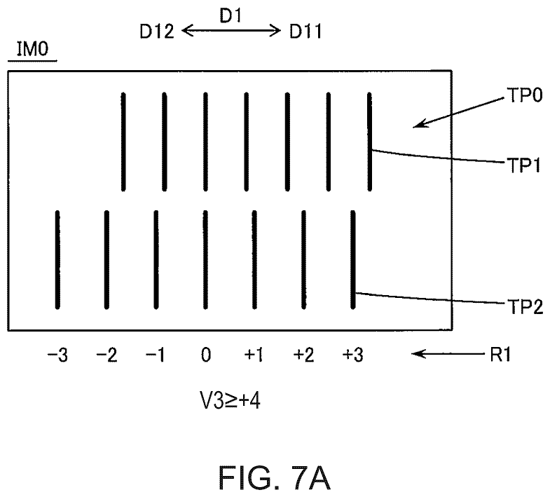

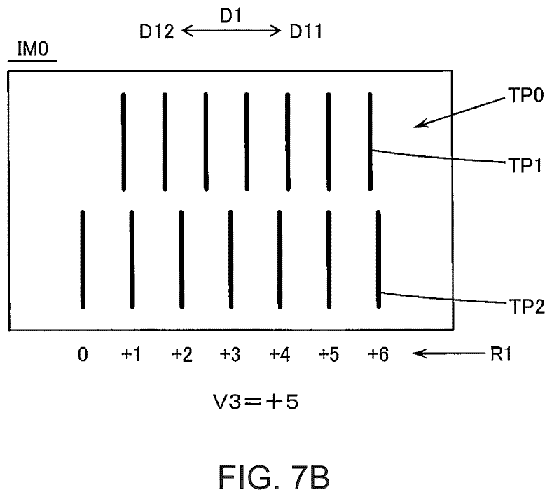

FIGS. 7A and 7B show schematic examples of a captured image IM0 that is acquired when the acceptable range R2 is equal to or greater than −6 and equal to or less than +6, and a provisional value V3=+5 within the acceptable range R2 is correctly determined.

The correction range R1 of the test pattern TP0 printed first is, as shown in FIG. 7A, based on the reference value V1=0 and ranges from the boundary value V2=−3 to the boundary value V2=+3. The main control section 110 performs processing to identify the position of the corresponding return pass individual pattern TP2 that matches the position of the forward pass individual pattern TP1, based on the test pattern TP0 included in the captured image IM0. Since the correction range R1 is equal to or greater than −3 and equal to or less than +3, the main control section 110 cannot obtain the provisional value V3=+5. The information terminal 1 determines the provisional value V3 to be +4 or greater based on the test pattern TP0 contained in the captured image IM0, changes the reference value V1 to the boundary value V2=+3, and causes the printing device 2 to print the test pattern TP0 as shown in FIG. 7B. The correction range R1 of the test pattern TP0 shown in FIG. 7B is from the boundary value V2=0 to the boundary value V2=+6. The information terminal 1 can obtain the provisional value V3 as +5 based on the test pattern TP0 included in the captured image IM0.

On the other hand, when the provisional value V3 cannot be obtained normally as shown in FIG. 5, the information terminal 1 may determine the provisional value V3 to be equal to or greater than +7 based on the test pattern TP0 included in the captured image IM0. In this case, the provisional value V3 cannot be used as the correction value V4 as it is. However, if it is determined that an error has occurred, the adjustment operation of the printing characteristics cannot be performed. In order to improve usability when adjusting printing characteristics based on the captured image IM0 of the test pattern TP0, the information terminal 1 of this specific example determines the correction value V4 to be an alternative correction value V5 that is inside the boundary R2b of the acceptable range R2, for example, +4 or +5.

### (3) Specific Example of Correction Value Determination Process

FIG. 8 shows an example of the correction value determination process performed by the main control section 110. Here, the steps S104 to S106 correspond to the image acquisition process ST1. The steps S108 to S116 correspond to the judgment process ST2 and the judgment function FU1. The step S118 corresponds to the first correction value determination process ST3 and the first correction value determination function FU2. The step S120 corresponds to the second correction value determination process ST4 and the second correction value determination function FU3. Hereinafter, the word “step” may be omitted, and reference numeral of steps may be indicated in parentheses.

When the correction value determination process starts, the main control section 110 assigns 1 to a variable N that indicates the number of times of execution of the print imaging process of S104 to S106 (S102). Next, the main control section 110 causes the printing device 2 to print a test pattern TP0 for obtaining a provisional value V3 within a predetermined correction range R1 with reference to the reference value V1 for adjustment during the Nth printing (S104). In the example shown in FIG. 6, the correction range R1 for the N=1 time is −3 or more and +3 or less with reference to the reference value V1=0.

After the S104 is processed, the user US1 performs work of capturing an image of the test pattern TP0 while holding the information terminal 1 in his/her hand. When the main control section 110 receives an operation of the shutter button included in the operation section 115, the main control section causes the imaging section 120 to capture the test pattern TP0, and acquires the captured image IM0 generated by the imaging section 120 from the imaging section 120 (S106).

After the process of S106, the main control section 110 determines a provisional value V3 of the correction value V4 based on the test pattern TP0 included in the captured image IM0 (S108). For example, the main control section 110 performs processing to identify the position of the corresponding return pass individual pattern TP2 that matches the position of the forward pass individual pattern TP1 in the main scanning direction D1 based on the test pattern TP0 in the captured image IM0. Then, the main control section 110 acquires the value V0 associated with the identified return pass individual pattern TP2 as the provisional value V3, or determines that the provisional value V3 is a value larger or smaller than the correction range R1 because the position of the return pass individual pattern TP2 cannot be identified. For example, when the correction range R1 is equal to or greater than −3 and equal to or less than +3, and the provisional value V3 is a value greater than the correction range R1, the main control section 110 determines that the provisional value V3 is equal to or greater than +4.

After the process of S108, the main control section 110 determines whether or not the error in the printing characteristics can be adjusted based on the provisional value V3 (S110).

When the provisional value V3 is outside the correction range R1, the correction value V4 cannot be determined from the provisional value V3, so the main control section 110 proceeds to S112 and determines whether the variable N is smaller than the upper limit number of times X. When N<X, the main control section 110 performs a correction amount feedback process to change the reference value V1 to the boundary value V2 of the correction range R1 (S114), adds 1 to the variable N (S116), and returns the process to S104. In S104, the main control section 110 causes the printing device 2 to print a test pattern TP0 for obtaining a provisional value V3 within the correction range R1 using the new reference value V1 as a reference. For example, when the provisional value V3 is +4 or more, the correction range R1 of the test pattern TP0 is 0 or more and +6 or less with the reference value V1=+3 as the reference. Thereafter, the process from S106 to S110 is performed. When the main control section 110 determines in S110 that the error in the printing characteristics cannot be adjusted, and determines in S112 that the variable N has reached the upper limit number X, the process proceeds to S120 and ends the loop of S104 to S116. Therefore, when the provisional value V3 obtained from the test pattern TP0 contained in the captured image IM0 is outside the correction range R1, the main control section 110 can change the reference value V1 to the boundary value V2 of the correction range R1 and execute the print imaging process of S104 to S106 (X−1) times.

When the provisional value V3 is included in the correction range R1 in S110, the main control section 110 advances the process to S118, determines the provisional value V3 to be the correction value V4, and ends the correction value determination process. The provisional value V3 being included in the correction range R1 means that the provisional value V3 is included in the acceptable range R2. Therefore, when the provisional value V3 obtained from the test pattern TP0 included in the captured image IM0 is included in a predetermined acceptable range R2, the main control section 110 determines the provisional value V3 as the correction value V4.

When the variable N reaches the upper limit number X in S112, the main control section 110 determines in S120 the alternative correction value V5, which is inside the boundary R2b of the acceptable range R2, as the correction value V4, and terminates the correction value determination process. When N≤X, the provisional value V3 being outside the correction range R1 means that the provisional value V3 is outside the acceptable range R2. Therefore, when the provisional value V3 is outside the acceptable range R2, the main control section 110 determines the alternative correction value V5 as the correction value V4.

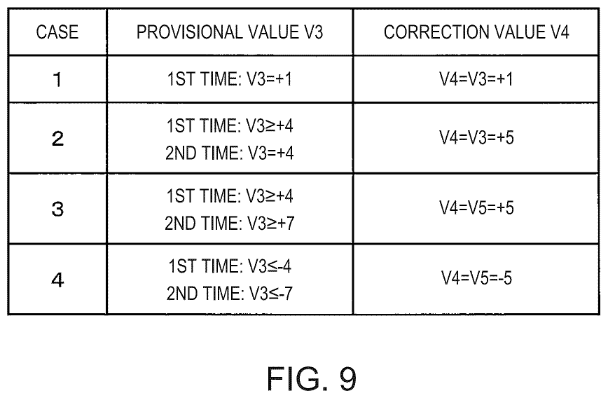

FIG. 9 illustrates a schematic example of a provisional value V3 obtained when a single correction range R1 is equal to or larger than V1−3 and equal to or smaller than V1+3, and the upper limit number of times X is 2, and a correction value V4 determined from the provisional value V3. Note that the alternative correction value V5 is +5 when the provisional value V3 is positive, and is −5 when the provisional value V3 is negative.

In case 1, where the provisional value V3=+1 is obtained from the test pattern TP0 printed and imaged for the first time, the provisional value V3 is included in the correction range R1, that is, the acceptable range R2, and thus the correction value V4 is determined to be the provisional value V3=+1.

In case 2, where the first provisional value V3 is equal to or greater than +4 the correction range R1 is changed to equal to or greater than 0 and equal to or less than +6, and the provisional value V3=+4 is obtained from the second test pattern TP0 that is printed and imaged, the provisional value V3 is included in the correction range R1, i.e., the acceptable range R2. Therefore, the correction value V4 is determined as the provisional value V3=+4.

In case 3, where the first provisional value V3 is equal to or greater than +4 and the second provisional value V3 is equal to or greater than +7 after the correction range R1 is changed to equal to or greater than 0 and equal to or less than +6, the provisional value V3 is outside the acceptable range R2, so the correction value V4 is determined to be the alternative correction value V5=+5.

In case 4, where the first provisional value V3 is equal to or less than −4, and the second provisional value V3 after the correction range R1 has been changed to equal to or greater than −6 and equal to or less than 0, the provisional value V3 is outside the acceptable range R2, so the correction value V4 is determined to be the alternative correction value V5=−5.

As described above, when the provisional value V3 of the correction value V4 is outside the acceptable range R2, the alternative correction value V5 inside the boundary R2b of the acceptable range R2 is determined as the correction value V4. By this, inconveniences can be avoided, such as inappropriate adjustment of the printing characteristics due to an impossible correction value V4, or the inability to perform the adjustment work of the printing characteristics due to an error. Therefore, this example can improve usability when adjusting print characteristics based on the captured image IM0 of the test pattern TP0 captured by the imaging section 120 separate from the printing device 2.

### (4) Modifications

Various modifications can be made to the present disclosure.

For example, even when the upper limit number of times X of the test pattern printing is 1 and the acceptable range R2 coincides with the correction range R1 with the reference value V1=0 as the reference, the basic effect of the present invention can be obtained. For example, in the test pattern TP0 shown in FIG. 7A, even if the provisional value V3 of the correction value V4 is equal to or greater than +4 or equal to or less than −4, an alternative correction value V5 that is equal to or greater than −2 and equal to or less than +2 is determined as the correction value V4, thereby avoiding the above-mentioned inconveniences.

As illustrated in FIG. 10, the main control section 110 may perform a process of changing the alternative correction value V5 in accordance with the provisional value V3 of the correction value V4.

The alternative correction values V5 shown in FIG. 10 include a first alternative correction value V51 and a second alternative correction value V52 between the first alternative correction value V51 and 0. In the example shown in FIG. 10, the positive alternative correction value V5 include a first alternative correction value V51=+3 and a second alternative correction value V52=+2 between +3 and 0. The negative alternative correction value V5 include a first alternative correction value V51=−3 and a second alternative correction value V52=−2 between −3 and 0. The first alternative correction value V51 is an alternative correction value that is applied to the correction value V4 when the provisional value V3 is outside of the expansion range R3 that is broader than the acceptable range R2. The second alternative correction value V52 is an alternative correction value that is applied to the correction value V4 when the provisional value V3 is outside the acceptable range R2 but is included in the expansion range R3. xxxIn FIG. 10, the acceptable range R2 is equal to or greater than −5 and equal to or less than +5, and the expansion range R3 is equal to or greater than −10 and equal to or less than +10.

For example, when the provisional value V3 is equal to or greater than +11, the provisional value V3 is outside the expansion range R3, and the main control section 110 determines the first alternative correction value V51=+3 as the correction value V4. When the provisional value V3 is equal to or less than −11, the provisional value V3 is also outside the expansion range R3, and the main control section 110 determines the first alternative correction value V51=−3 as the correction value V4. In either case, when the provisional value V3 is outside the acceptable range R2, or when the provisional value V3 is outside the expansion range R3 which is broader than the acceptable range R2, the main control section 110 determines the first alternative correction value V51 to be the correction value V4.

When the provisional value V3 is equal to or greater than +6 and equal to or less than +10, the provisional value V3 is outside the acceptable range R2 but is included in the expansion range R3, and the main control section 110 determines the second alternative correction value V52=+2 as the correction value V4. When the provisional value V3 is equal to or greater than −10 and equal to or less than −6, the provisional value V3 is outside the acceptable range R2 but is included in the expansion range R3, and the main control section 110 determines the second alternative correction value V52=−2 as the correction value V4. In either case, when the provisional value V3 is outside the acceptable range R2 and the provisional value V3 is included in the expansion range R3, the main control section 110 determines the second alternative correction value V52 as the correction value V4.

When the provisional value V3 is outside the expansion range R3, there is a high possibility that the printing characteristics deviate by a relatively large amount. On the other hand, when the provisional value V3 is outside the acceptable range R2 but is included in the expansion range R3, the deviation of the printing characteristics is likely to be smaller than that when the provisional value V3 is outside the expansion range R3. When the provisional value V3 is outside the acceptable range R2, the correction value V4 is determined according to the degree of deviation, and therefore, it is possible to determine more effective correction value V4 when adjusting the printing characteristics to some extent.

Note that the alternative correction value V5 may be divided into three or more levels. The correspondence relationship between the provisional value V3 and the alternative correction value V5 may be defined in an information table or may be defined by a mathematical formula.

### (5) CONCLUSIONS

As described above, according to the disclosure, and various aspects, it is possible to provide a configuration or the like that can improve usability when adjusting printing characteristics based on a captured image of a test pattern captured by an imaging section separate from a printing device. Of course, the above-described basic operations and effects can be obtained even in an aspect including only the constituent features according to the independent claims.

What is claimed is:

1. A printing system comprising:
a printing device that prints, on a medium, a test pattern for determining a correction value used for adjusting a printing characteristic;
an imaging section that is separate from the printing device and that generates a captured image of the test pattern by capturing the test pattern; and
a control section that acquires the captured image from the imaging section and that performs processing of determining the correction value, wherein
the control section
when a provisional value of the correction value is included in a predetermined acceptable range, determines the provisional value to be the correction value, the provisional value being obtained from the test pattern included in the captured image and
when the provisional value is outside the acceptable range, determines an alternative correction value that is inside a boundary of the acceptable range as the correction value.

2. The printing system according to claim 1, wherein
the control section
causes the printing device to print the test pattern for obtaining the provisional value within a predetermined correction range with a reference value for the adjusting as a reference and performs a print imaging process of causing the imaging section to capture an image of the test pattern to acquire the captured image from the imaging section,
assuming that X is an integer equal to or greater than 2, when the provisional value determined from the test pattern included in the captured image is outside the correction range, the reference value is changed to a boundary value of the correction range and the print imaging process is executed (X−1) times, and
the acceptable range is X times the correction range.

3. The printing system according to claim 1, wherein
the correction value is a value that can be positive or negative with 0 as a reference to when the printing characteristic is not adjusted and
the alternative correction value is a positive value smaller than the provisional value when the provisional value is positive, and is a negative value larger than the provisional value when the provisional value is negative.

4. The printing system according to claim 3, wherein
the alternative correction value includes a first alternative correction value and a second alternative correction value between the first alternative correction value and 0 and
the control section
determines the first alternative correction value as the correction value when, in a case where the provisional value is outside the acceptable range and
the provisional value is outside an expansion range that is broader than the acceptable range and determines the second alternative correction value as the correction value when, in a case where the provisional value is outside the acceptable range, the provisional value is included in the expansion range.

5. A correction value determination method for determining a correction value using a printing device that prints, on a medium, a test pattern for determining a correction value used for adjusting a printing characteristic and an imaging section that is separate from the printing device and that generates a captured image of the test pattern by capturing the test pattern, the correction value determination method comprising:
an image acquisition step for acquiring the captured image from the imaging section;
a first correction value determination step of determining a provisional value of the correction value as the correction value when the provisional value is included in a predetermined acceptable range, the provisional value being obtained from the test pattern included in the captured image; and
a second correction value determination step for determining an alternative correction value within the acceptable range that is inside the boundary of the acceptable range as the correction value when the provisional value is outside the acceptable range.
